(19) United States
(12) Patent Application Publication
(10) Pub. No.: US 2009/0080763 A1
(43) Pub. Date: Mar. 26, 2009

(54) METHOD AND SYSTEM FOR THE VISUAL CLASSIFICATION OF DEFECTS

(75) Inventors: JACK Y. JAU, Los Altos Hills, CA (US); ZHAOLI ZHANG, San Jose, CA (US); WEI FANG, Milpitas, CA (US)

Correspondence Address: SAWYER LAW GROUP LLP, 2465 E. Bayshore Road, Suite No. 406, PALO ALTO, CA, 94303, US

(73) Assignee: HERMES MICROVISION, INC, Milpitas, CA (US)

(21) Appl. No.: 12/323,459

(22) Filed: Nov. 25, 2008

Related U.S. Application Data
(63) Continuation of application No. 11/626,795, filed on Jan. 24, 2007.

(51) Int. Cl. G06T 7/00

(52) U.S. Cl. 382/149

(57) ABSTRACT

A method and system for the classifying of defects in a device is disclosed. The method and system comprises directly classifying samples based upon a feature space; and creating knowledge from the samples of a feature group within the feature space for a supervised classifier. Finally, the method and system includes selecting features to create a best feature group from the feature space for a particular classification of defects. A visual classifier in accordance with the present invention is utilized in three different ways to improve speed and accuracy of the classification. First, the visual classifier directly classifies data. Second, the visual classifier can help to create knowledge about the defects quickly and correctly. Third, a feature selection process is also performed by the visual classifier in accordance with the present invention.

### CROSS-REFERENCE TO RELATED APPLICATIONS

This application is a continuation-in-part U.S. patent application Ser. No. 11/626,795, entitled “Method And System For Creating Knowledge And Selecting Features In A Semiconductor Device”, filed on Jan. 24, 2007, all of which is incorporated herein by reference.

### FIELD OF THE INVENTION

The present invention relates generally to semiconductors and more specifically to a system and method for classifying defects in a semiconductor device.

### BACKGROUND OF THE INVENTION

After the manufacturing of a semiconductor wafer it is important to be able to detect and classify defects on the wafer. Typically, the defects are classified by different types of defect such as shorts or opens and by the characteristics of the defects. What is meant by the characteristics of the defects is by, for example, size, roundness, direction of the defect etc.

In the semiconductor industry, automatic defect classification (ADC) has been used to overcome the labor intensive disadvantages of manually classifying the defects. Conventional ADC systems include two types of classifiers: (1) a supervised classifier, and (2) an unsupervised classifier. Although the supervised classifier is widely utilized, a number of problems exist with its use. The most critical and difficult problem is determining all of the characteristics that define various defects. In the field, the application engineer typically does not have time to finish this task and defining the various characteristics of the various defects is typically too difficult for an engineer that does not have extensive experience in the field. Accordingly, determining the characteristics of the various defects requires an individual to have a great deal of experience. Even with an engineer that has the requisite knowledge there still is a chance for significant inaccuracy to use same characteristics in all case.

Although the unsupervised classifier does not need special knowledge or training, and uses only the features' distribution to cluster the data, the overlap or confused features will have an adverse impact on the classifier performance.

Accordingly, what is desired is to provide a visual classifier that overcomes the above-identified issues. The present invention addresses such a need.

### SUMMARY OF THE INVENTION

A method and system for the classifying of defects in a device is disclosed. The method and system comprises directly classifying samples based upon a feature space; and creating knowledge from the samples of a feature group within the feature space for a supervised classifier. Finally, the method and system includes selecting features to create a best feature group from the feature space for a particular classification of defects.

A visual classifier in accordance with the present invention is utilized in three different ways to improve speed and accuracy of the classification. First, the visual classifier directly classifies data. Second, the visual classifier can help to create knowledge about the defects quickly and correctly. Third, a feature selection process is also performed by the visual classifier in accordance with the present invention.

### BRIEF DESCRIPTION OF THE DRAWINGS

FIG. 1 is a diagram of a system for the visual classification of defects in accordance with the present invention.

FIG. 2 is a flow chart which depicts the operation of the visual classifier in accordance with the present invention.

FIG. 3 illustrates a one dimensional visual classifier element.

FIG. 4 shows the general one dimensional visual classification model.

FIGS. 5 and 6 illustrate the two dimensional visual classifier and its general model.

FIG. 7 shows a three dimensional visual classifier element.

FIG. 8A illustrates a first method of the direct classification process.

FIG. 8B illustrates a second method of the direct classification process.

FIG. 8C shows corresponding points in a different space.

FIG. 8D shows corresponding samples highlighted.

FIG. 9 shows a sample selection using the visual classifier.

FIG. 10A shows a first method by which knowledge is created by the visual classifier.

FIG. 10B shows a second method by which knowledge is created by the visual classifier.

FIG. 11 shows feature selection using the visual classifier in accordance with the present invention.

FIG. 12 illustrates the feature selection working flow in detail.

### DETAILED DESCRIPTION

The present invention relates generally to semiconductors and more specifically to a system and method for classifying defects in a semiconductor device. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

### DEFINITION OF TERMS/CONCEPTS

Samples—Items to be classified.

Sample set or data set—The whole set of sample.

Knowledge—The information which is saved and used in the classifier to characterize the samples is called knowledge.

Training samples—The samples which are used to obtain the knowledge.

Training set—The whole set of training samples.

Test samples—The samples which are utilized to verify the classifier.

Test set—The set of training samples to be tested.

Review type—The sample type provided by the manual characterization.

ADC type—The classification type labeled by the classifier.

Attribute—The property of the samples which is utilized to distinguish different samples. The attribute is also referred to as a feature of the sample.

Feature space—The display that includes a representation of the samples' feature.

### Visual Classifier

A visual classifier is provided in accordance with present invention to allow for more accurate classification of defects without requiring specialized knowledge by the user. In so doing, defects can be identified more accurately, quickly and easily than has been possible with conventional supervised and unsupervised classifiers. In addition the visual classifier can be utilized with conventional classifiers to provide for accurate defect classification.

A visual classifier in accordance with the present invention is utilized in three different ways to improve speed and accuracy of the classification. First, the visual classifier directly classifies data. In classifying data directly, all of the attributes of the samples can be seen and the samples can be labeled directly. Even in the case of overlap of attributes, the classes can be outlined by zooming in or changing the view by selecting different features.

Second, the visual classifier can help to create knowledge about the defects quickly and correctly. The visual classifier in accordance with the present invention can also create knowledge for other classifiers. The visual classifier can be utilized to obtain training samples which will save time compared to reviewing data one item at a time. Some key parameters, such as a threshold in a rule based classifier, can also be decided by the visual classifier easily and effectively.

Third, a feature selection process is also performed by the visual classifier in accordance with the present invention. The feature selection process provides for better classification performance and increases the speed of the classification process, thereby resulting in greater efficiency. To describe the features of a visual classifier in more detail, refer now to the following description in conjunction with the accompanying figures.

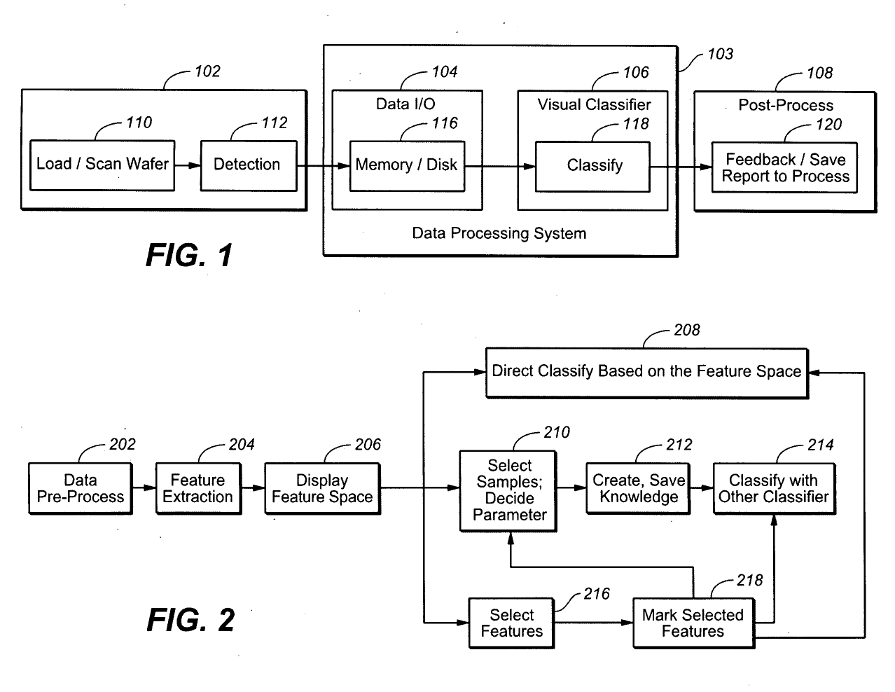

FIG. 1 is a diagram of a system 100 for the visual classification of defects in accordance with the present invention. The system includes a detector mechanism 102 coupled to a data processing system 103. The detector mechanism 110 includes a loading/scanning system 104 for loading and scanning a semiconductor wafer. The scanned information is provided to a detector 112 such as an electron beam detector. The data processing system comprises a data I/O 104, which allows for saving defects to a memory/disk 116. This defect information is provided to a visual classifier 106 which classifies 118 the defects. The data processing system 103 may or may not include a post process system 108 for providing a report or feedback for the classified defects.

In a preferred embodiment, the data processing system is a personal computer and the visual classifier comprises a software application that runs thereon. However, one of ordinary skill in the art readily recognizes that the software can be stored on a computer readable medium such as a floppy disk, disk drive, DVD, CD, Flash memory or the like and it use would be within the spirit and scope of the present invention. Furthermore the software application could be downloaded or transmitted via a public or private network and the signal provided therefrom and that use would be within the spirit and scope of the present invention.

FIG. 2 is a flow chart which depicts the operation of the visual classifier 106 in accordance with the present invention. As before mentioned the visual classifier is utilized for three different purposes, direct classification of defects, creating knowledge about the defects for other classifier and providing feature selection. Each of these purposes utilizes steps 202-206.

Accordingly, the samples are pre-processed 202. In the wafer inspection system, some image filters will be employed to reduce noise and many image processing methods will be used to enhance the defect image. After pre-processing, the features will be extracted, via step 204. If this is not the first time and the features have been selected before, all that is needed is to extract the better features. Next, the feature space is displayed via step 206. Displaying the feature space is a key step in the visual classifier.

The visual classifier includes a plurality of visual classifier elements. In an embodiment, those elements are a one dimensional (1D) visual classifier element, a two dimensional (2D) visual classifier element, and a three dimensional (3D) visual classifier element. Normalization is needed before displaying the feature space for the 2D and 3D visual classifiers. The 1D, 2D and 3D feature space can be selected to be displayed for a difficult case or just one or two depending on the complexity of the case. The 1D, 2D and 3D visual classifier elements are described in more detail hereinbelow in conjunction with the accompanying figures.

### One Dimensional (1D) Visual Classifier Element

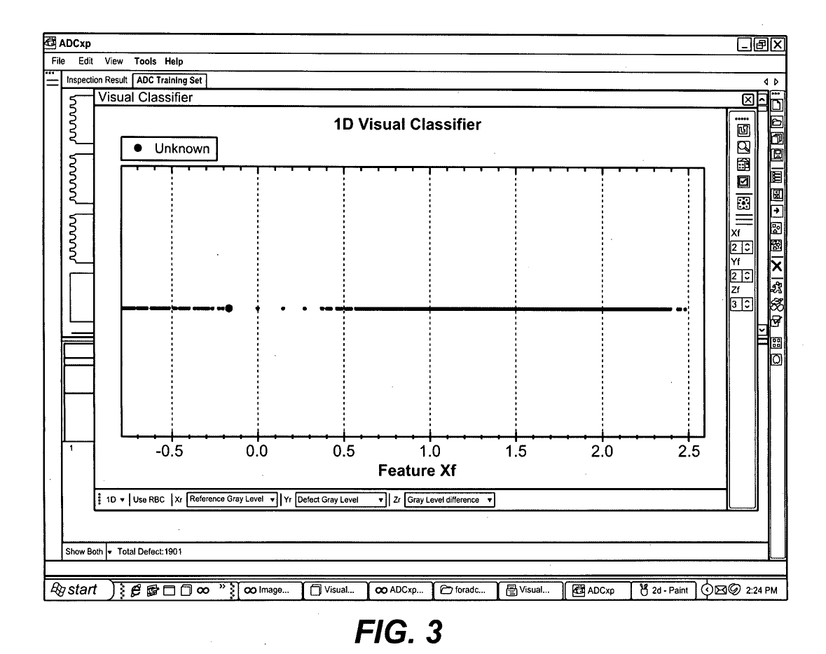

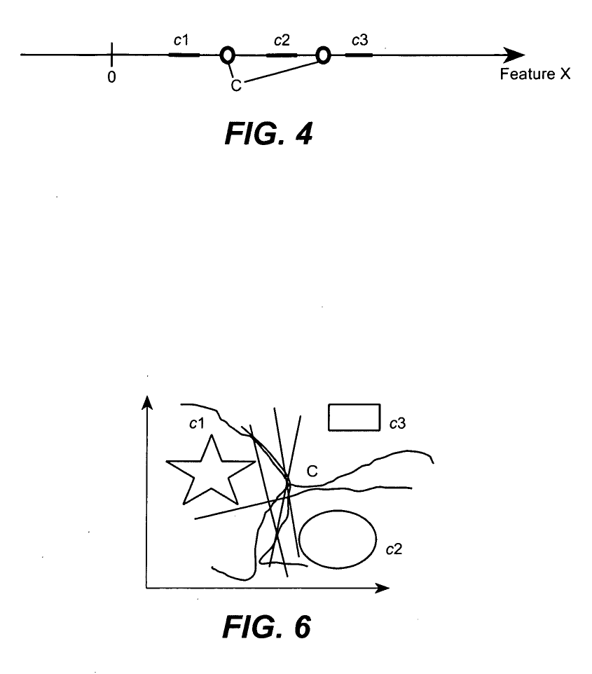

FIG. 3 illustrates a one dimensional visual classifier element. As is shown in FIG. 4, the samples can be divided by a feature Xf easily. FIG. 4 shows the general one dimensional visual classification model. The classifier is currently located at point C in FIG. 4. The location of point C can be determined depending on FIG. 4. Especially when a rule based classifier is utilized, the 1D visual classifier element allows for easy identification of the rule's threshold.

### Two Dimensional (2D) Visual Classifier Element

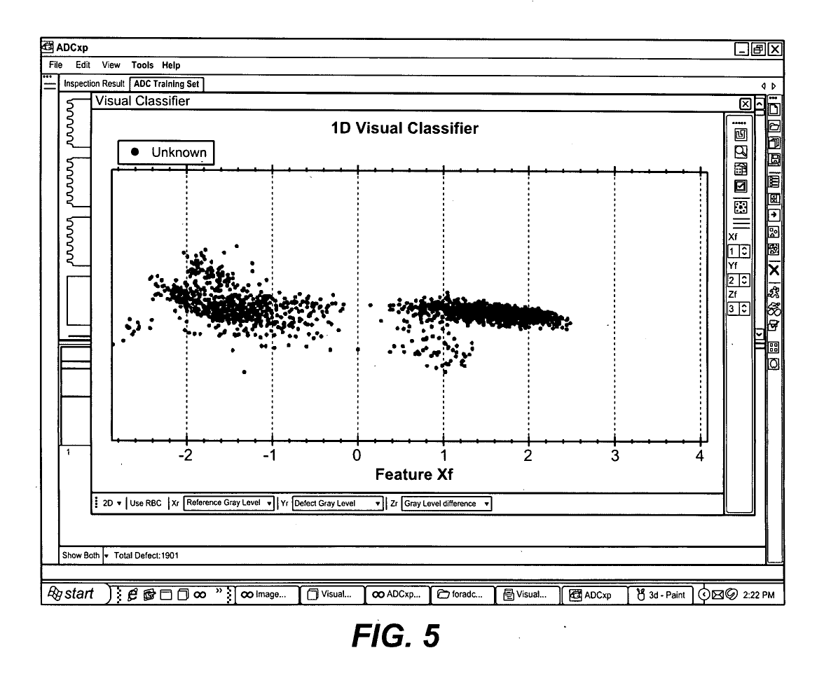

FIGS. 5 and 6 illustrate the two dimensional visual classifier and its general model. The difference between the one dimensional (1D) visual classifier and the two dimensional (2D) visual classifier is that the two dimensional classifier can classify defects in two directions (x, y). From FIG. 6 it can be seen that many classifiers (indicated by the various lines) can be selected. Typically, the shortest distance sum is the criteria to select the classifier. This shortest distance sum requires a great deal of computation and sometimes fails, especially when there are too many samples or the curve is too difficult to fit. But in the 2D visual classifier, a curve of any complexity can be dragged and drawn to fit the outline of the classifier. Even in the overlap case, one favorable curve can be set to emphasize one type of defect or to make a trade off among the different types of defects.

### Three Dimensional (3D) Visual Classifier Element

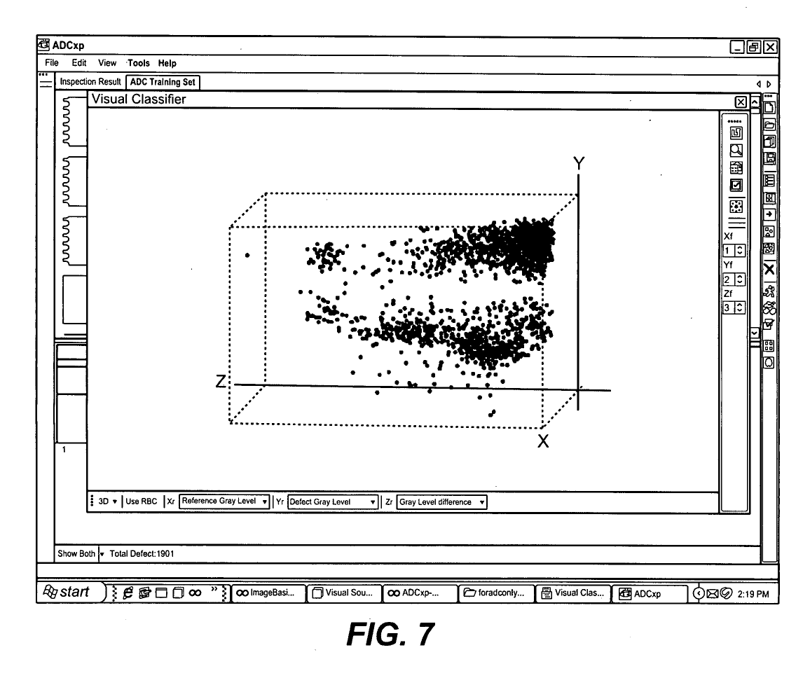

A three dimensional (3D) visual classifier element is shown in FIG. 7. In the three dimensional (3D) visual classifier three features can be seen at the same time. The 3D visual classifier makes it possible for the user to view the defects in the directions (x, y and z) in order to classify the samples more accurately than when using the 1D and 2D visual classifiers. In FIG. 7, the feature space is expanded in the third direction from the 2D visual classifier, just as the 2D visual classifier is expanded in the second direction from the 1D visual classifier. In the case shown in FIG. 7, the user can drag one line to create one plane between the two clustering points to classify the defects.

### Purposes of the Visual Classifier

As mentioned above, the visual classifier can be utilized for three different purposes (1) directly classify sample, (2) help to create knowledge and (3) select features. Now, the relation between the three purposes and their use are described in detail below.

### Direct Classification 208

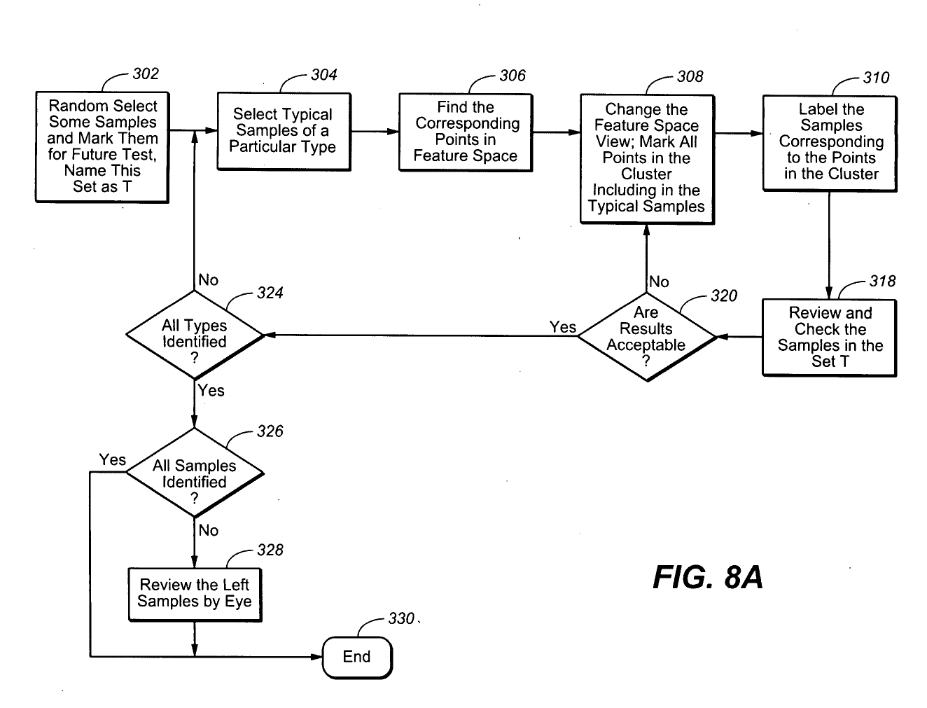

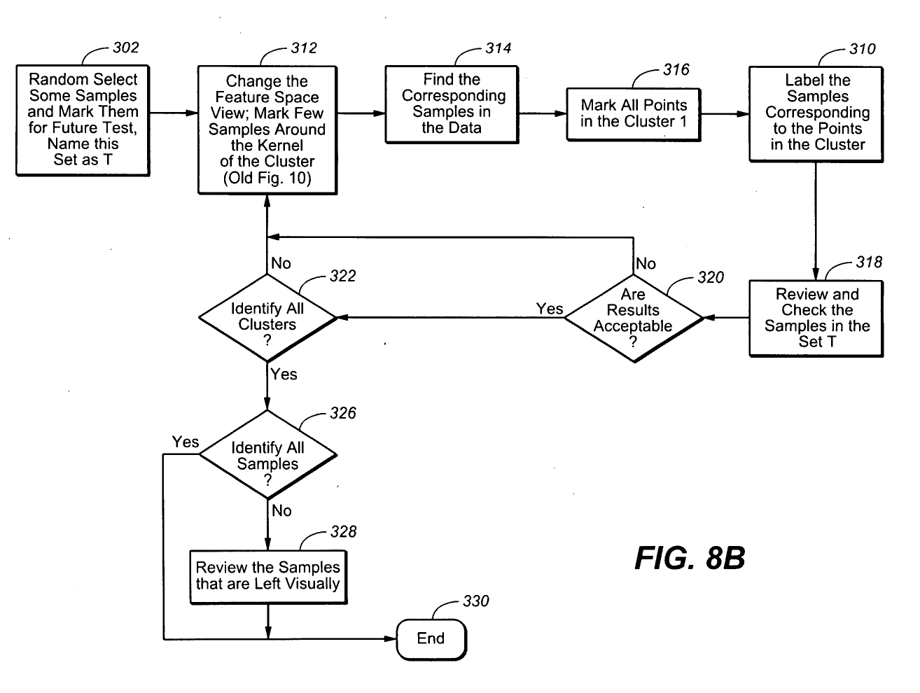

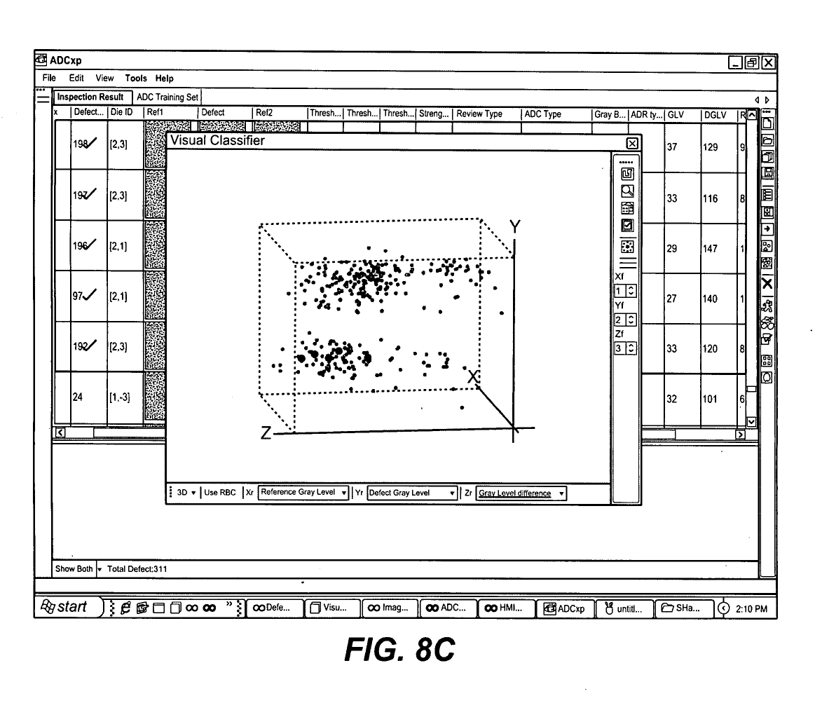

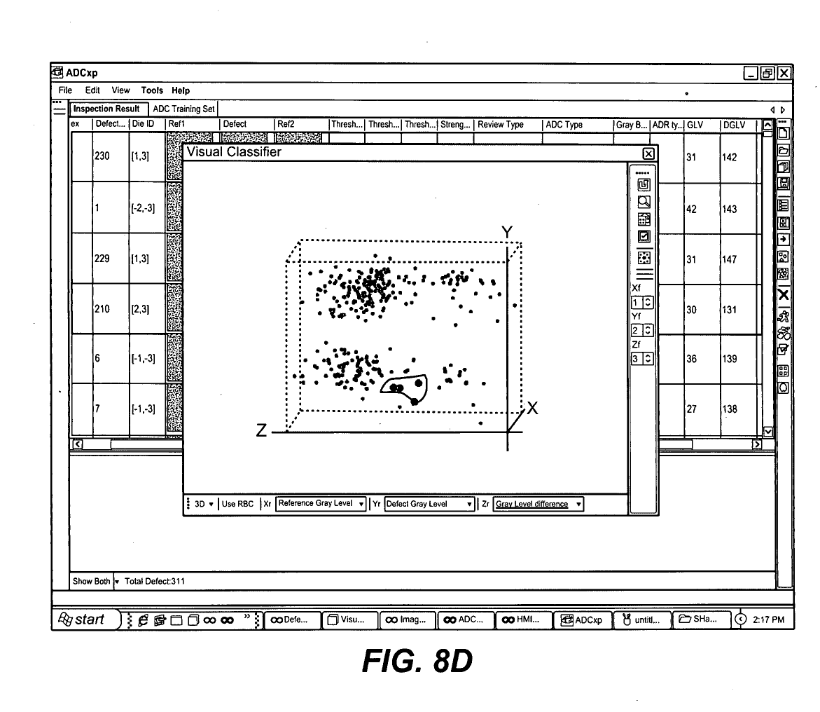

Direct classification, is typically performed offline. What is meant by offline is that the classification will be started after all the data has been obtained. There are two different methods which may be used to realize direct classification. FIG. 8A illustrates one embodiment of the direct classification process. FIG. 8B illustrates a second embodiment of the direct classification process. For both methods, one random selected test sample set T should be created first, via step 302. Normally this test sample set T includes very few samples compared to the whole data set.

### Method 1

Referring now to FIG. 8A, the first method to select some typical defects from a data set and select typical samples of a particular type, via step 304. Then, the corresponding points in the feature space are determined, via step 306. Next, the feature space view is changed and all points in a cluster of defects are marked are included in the typical samples, via step 308. At the same time as these samples are selected, the corresponding points will be shown in a different space as shown in FIG. 8C. Now all the points in the feature space can be labeled as one type. The samples are then labeled corresponding to the points in the cluster, via step 310. After reviewing and checking the samples in the set T, via step 318, if the result is not acceptable, the feature space view can be changed to mark points until the desired results are realized, via step 308. If the results are acceptable, then it is determined if all the types have been identified, via step 324. If all the types have not been identified, return to step 304. If all the types have been identified, it is then determined if all the samples have been identified, via step 326. If not, the remaining samples are reviewed manually, via step 328. If all the samples have been identified, proceed to the end, via step 330.

### Method 2

Referring now to FIG. 8B, first some samples are randomly selected and then marked for future test. This set is then referred to as test set (T), via step 302. The second method involves first selecting a plurality of points in one cluster shown in the feature space. First, the feature space view is changed, and a few samples are marked that are proximate to a kernel or centroid of the cluster, via step 312. Next, the corresponding samples are auto found in the sample set, via step 314. Then, all points in the cluster are marked, via step 316. As shown in FIG. 8D, the corresponding samples will be highlighted so that they can be reviewed and all the samples corresponding to the points in this cluster are labeled according to the type used, via step 310. Then the result in the test set T is checked until the results are acceptable (via step 320). After reviewing and checking the samples in the set T, via step 318, if the result is unacceptable, the feature space view is changed, via step 312, to mark points until the desired results are realized. If after the desired results are realized, it is then determined if all the clusters have been identified, via step 322. If all the clusters have not been identified, return to step 312. If all the clusters have been identified, it is then determined if all samples have been identified, via step 326. If all samples have not been identified, the samples that have not been identified are reviewed visually, via step 328. If all the samples have been identified, proceed to the end, via step 330. These steps are then repeated until all the clusters are labeled. After the steps mentioned above are completed for both methods, some samples may be left and not classified. These samples should be manually classified.

### Using the Visual Classifier to Help Create Knowledge

The second purpose for which the visual classifier is utilized is to help to create knowledge for a supervised classifier. Referring back to FIG. 2, in creating knowledge first samples are selected and a parameter is decided upon, via step 210. Next, the knowledge is created and saved via step 212. The creation of knowledge will be described in detail hereinbelow. Finally, the data can be utilized by a supervised classifier, via step 214.

As mentioned above, a supervised classifier's performance depends on the knowledge obtained from training samples. But there are many aspects which affect the selection of good samples. As before mentioned, typically the user's experience controls the selection of good samples. Months, even years are needed to get this kind of experience. Previous experience may provide a limited benefit and may even be detrimental when a condition is changed. On the other hand, in a case where there are too many samples for the candidate to select, (for example, in an instance where 200,000 defects occur after a short time wafer inspection), it is almost impossible to review these defects one by one, and when they are sampled by certain rules, there is the risk of getting wrong distribution of the samples or missing some important information.

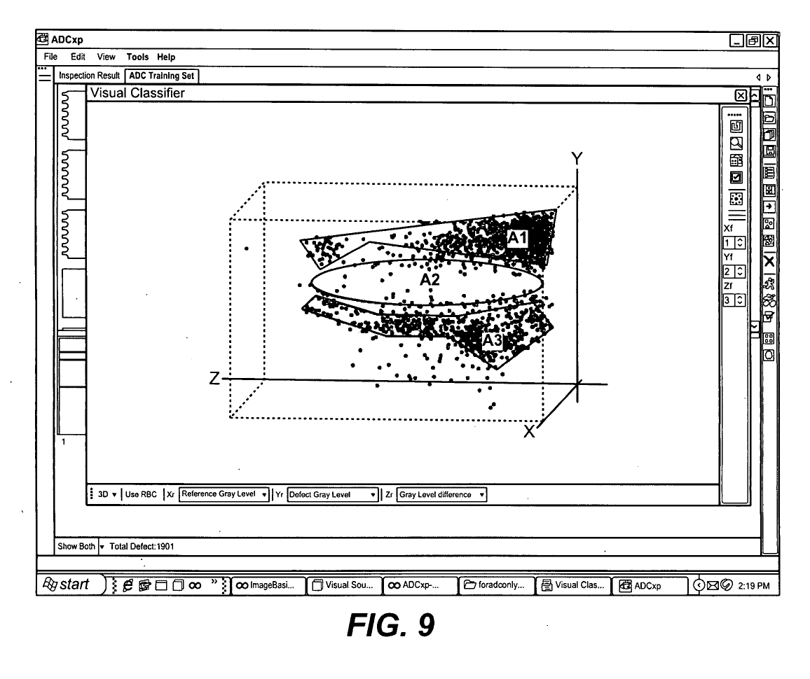

The visual classifier in accordance with the present invention solves this problem. FIG. 9 shows a sample selection using the visual classifier. As shown in FIG. 9, there are two sample types. Area A1 and area A3 can be seen as their distribution space. Once the user has obtained the distribution of the total samples, the only remaining task is to select the samples depending upon the user's needs. To illustrate a first method for utilizing the visual classifier to obtain knowledge for a supervised classifier refers now to the following discussion.

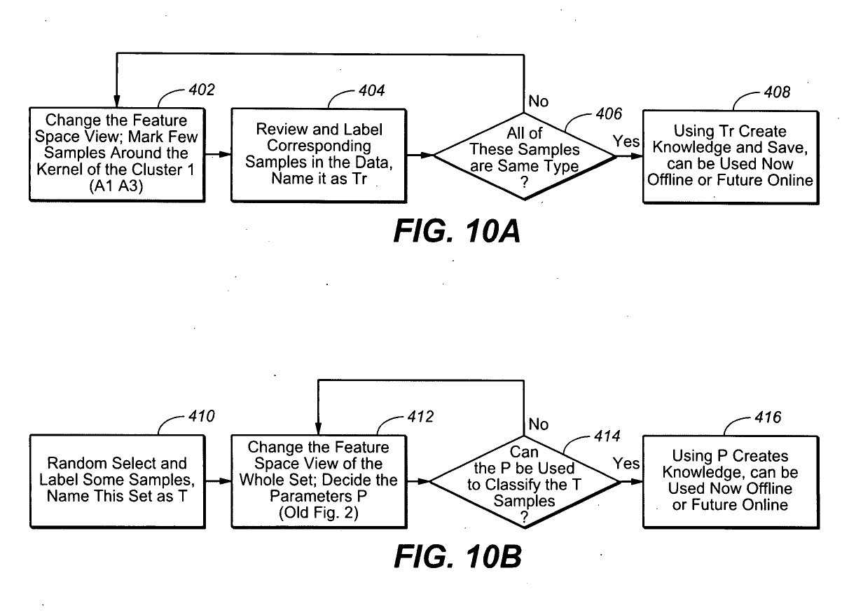

FIGS. 10A and 10B show the first and second methods by which knowledge is created by the visual classifier. They will be described in detail hereinbelow.

### Method 1

Referring now to FIG. 10A, this method creates knowledge beginning from the feature space view. In this method, first the feature space view is changed, and a few samples around the kernel of the cluster of defects are marked, via step 402. Next, the corresponding samples will be auto shown and can be reviewed and labeled in the sample set as a set of training samples (Tr), via step 404. Then, it is determined if training samples are of the same type, via step 406. If they are not the same type, return to step 402. If they are of the same type, Tr is utilized to create knowledge about the defects, via step 408. This knowledge can be used now offline or online in the future.

For some classifiers, specified training samples are not needed, but there are still some parameters which must be decided upon before they are used, either online or offline. Just as is shown in FIG. 4, the point C can be determined and then saved as knowledge to use in the future. To illustrate a method for utilizing the visual classifier to obtain knowledge for a supervised classifier utilizing parameters, refer now to the following.

### Method 2

Referring now to FIG. 10B, a second method requires some parameters, for example, a threshold in a rule based classifier, to be obtained from the visual classifier directly to create knowledge for some special supervised classifiers. In this method, some samples are randomly selected and labeled as test samples (T) via step 410. Next, the feature space view of the whole samples is changed, and the parameters P are decided upon, via step 412. Then it is determined if the parameters can be used to classify the T test samples, via step 414. If the classification performance using the parameters is not good as desired, return to step 412. If the performance is good enough, the parameters are utilized to create knowledge, via step 416. The knowledge can be used now offline or online in the future. After the knowledge is saved, it can be utilized to perform the task online. Online means that the sample will be classified when it appears.

### Feature Selection

Referring back to FIG. 2, to select features related to the defect, first the appropriate features are selected, via step 216 and then the selected features are marked, via step 218. Features are a value extracted from the original samples to represent these samples. The features are of a reduced dimension compared to the original samples. Both an unsupervised and an supervised classifier performance depend on these features. Separability, overlap and compactness are three measurements taken into consideration in order to select features. Conventional feature selection methods are of two types. One type is the exhaustive searching method according to the classification rate by creating knowledge using all kind of feature groups. The other feature selection type utilizes a global search by computing the features' correlations and dependences. Both of these two methods' computation will grow exponentially with an increasing the features count.

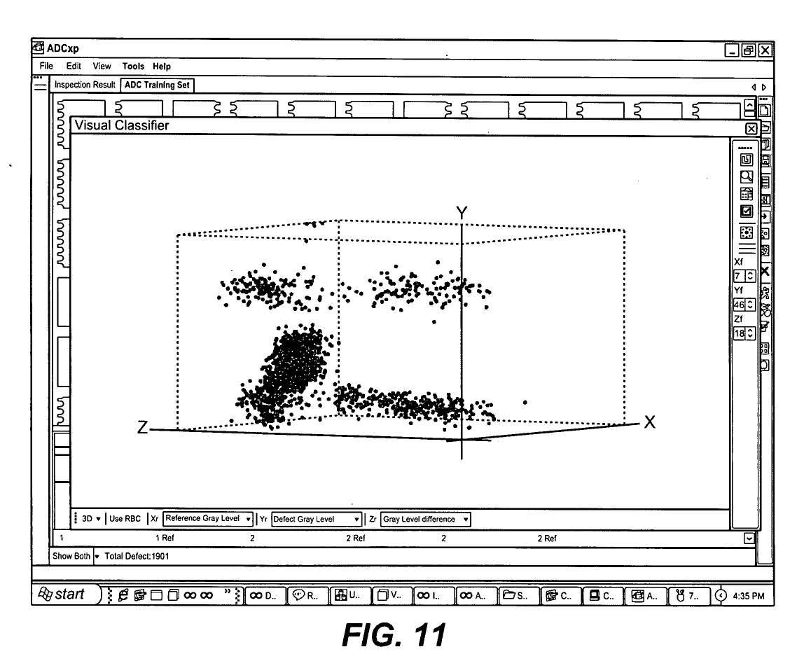

The visual classifier in accordance with the present invention can solve the computation problem in the feature selection. FIG. 11 shows feature selection using the visual classifier in accordance with the present invention. As shown in FIG. 11, the 40th feature is the best than any other single feature in the feature group. Indeed, the samples shown in FIG. 3, FIG. 6, FIG. 9 and FIG. 11 are the same. From these figures it can be seen clearly that if it is desired to classify the total samples into two categories, then selecting only features 1st and 46th is enough to provide a feature group. Assuming that there is a total of 64 features, the entire feature selection process can be finished in three steps in the following manner:

Step 1. First make a selection using the 1D visual classifier. By selecting the features, for example, 64 times, for example, approximately 8 best features are obtained.

Step 2: Use the 2D visual classifier to carry out the selection process. In this embodiment, for example approximately 5 best features are obtained by selecting the features no more than 5*28 times.

Step 3. Use the 3D visual classifier to confirm the selection. In this embodiment, the four best features of 5 are obtained after selecting around 3*10 times. Thereafter only a few minutes are needed to finish the process.

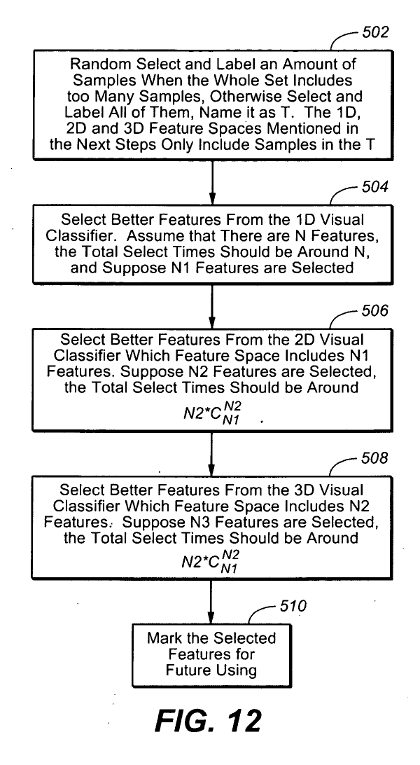

FIG. 12 illustrates the feature selection working flow in detail. Compared to other methods, the visual classifier can save time especially when the number of good features is small or when the feature count is limited by a real time process.

Referring to FIG. 12, a predetermined number of samples are randomly selected and labeled as a set of test samples (T), via step 502. Next, the better features are selected utilizing the 1D visual classifier. For example, there may be N (64) features, the total select times should be around 64, and N1 (8) features may be selected. Then, the better features are selected utilizing the 2D visual classifier where the feature space includes N1 (8) features.

At this point, for example, N2 (4) features are selected and the total select times should be no more than N2*C_{N1}^{N2}, via step 506. Now, select better features from the 3D visual classifier which feature space includes N2 (4) features. Suppose N3 (3) features are selected, the total select times should be around N2*C_{N1}^{N2}, via step 508. Finally, mark the selected features for future use, via step 510.

The visual classifier can be combined together with both the rule based ADC and the model based ADC to provide more accurate classification of defects. For the rule based ADC, the visual classifier can not only provide the best rules but it can also give the rule threshold. For the model based ADC, after the model is extracted, the visual classifier can be used to select the best features and to adjust the model to have a good tolerance. The visual classifier also can provide the clustering number which is very important to some unsupervised classifiers.

### CONCLUSION

A visual classifier is disclosed. It can classify data directly, help to create knowledge and to select features. The present invention also can be combined together with many exist algorithms to finish different tasks, such as data analysis, data mining and data fusion.

Although each of these three purposes has been described separately, they will be used at the same time in most cases, in the same way as the feature selection's result can be used to create knowledge or to direct classify.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A computer-implemented method for the classifying of defects in a semiconductor device, the method comprising:
directly classifying samples based upon a feature space;
creating knowledge from the samples of a feature group within the feature space; and
selecting features to create a best feature group from the feature space for a particular classification of defects based upon the feature space.

2. The computer-implemented method of claim 1 wherein the directly classifying step comprises displaying the feature space in any combination of a one dimensional feature space, two dimensional feature space and a three dimensional feature space.

3. The computer-implemented method of claim 1 wherein the direct classifying step comprises:
providing a feature space on a display that illustrates a plurality of defects; and
utilizing at least one visual classifier element to classify the defects in at least one direction.

4. The computer-implemented method of claim 3 wherein the at least one classifier element comprise any and any combination of a one dimensional classifier element in which features are identified in one direction (x), a two dimensional classifier element in which features can be identified in two directions (x and y), and a third classifier element in which features can be identified in three directions (x, y and z).

5. The computer-implemented method of claim 1 wherein the knowledge is created from training samples.

6. The computer-implemented method of claim 1 wherein the knowledge is created from parameters.

7. The computer-implemented method of claim 1 wherein creating knowledge comprises:
changing a feature space of a plurality of defects;
marking at least a portion of the samples of the defects in the feature space;
labeling the at least a portion of the samples as training samples;
determining if the training samples are of the same type; and
creating knowledge based upon the training samples if the samples are of the same type.

8. The computer-implemented method of claim 7 wherein changing the feature space comprises:
randomly selecting and labeling some samples as a set; and
changing the feature space view of the set.

9. The computer-implemented method of claim 1 wherein creating knowledge comprises:
changing a feature space of a plurality of defects;
marking at least a portion of the samples of the defects in the feature space;
labeling the at least a portion of the samples as a T set element;
changing the feature space of the T set element;
deciding upon appropriate parameters;
determining if the parameters can be used to classify the T set element; and
creating knowledge based upon the parameters if the parameters are used.

10. A computer readable medium containing program instructions for the classifying of defects in a semiconductor device, the program instructions comprising:
directly classifying samples based upon a feature space;
creating knowledge from the samples of a feature group within the feature space; and
selecting features to create a best feature group from the feature space for a particular classification of defects based upon the feature space.

11. The computer readable medium of claim 10 wherein the at least one type of defects comprises a plurality of types of defect.

12. The computer readable medium of claim 11 wherein the directly classifying step comprises displaying the feature space in any combination of a one dimensional feature space, two dimensional feature space and a three dimensional feature space.

13. The computer readable medium of claim 11 wherein the direct classifying step comprises:
providing a feature space on a display that illustrates the plurality of defects; and
utilizing at least one visual classifier element to classify the defects in at least one direction.

14. The computer readable medium of claim 13 wherein the at least one classifier element comprise any and any combination of a one dimensional classifier element in which features are identified in one direction (x), a two dimensional classifier element in which features can be identified in two directions (x and y), and a third classifier element in which features can be identified in three directions (x, y and z).

15. The computer readable medium of claim 10 wherein the knowledge is created from training samples.

16. The computer readable medium of claim 10 wherein the knowledge is created from parameters.

17. The computer readable medium of claim 10 wherein creating knowledge comprises:
changing a feature space of a plurality of defects;
marking at least a portion of the samples of the defects in the feature space;
labeling the at least a portion of the samples as training samples;
determining if the training samples are of the same type; and
creating knowledge based upon the training samples if the samples are of the same type.

18. The computer readable medium of claim 17 wherein changing the feature space comprises:
randomly selecting and labeling some samples as a set; and
changing the feature space view of the set.

19. The computer readable medium of claim 10 wherein creating knowledge comprises:
changing a feature space of a plurality of defects;
marking at least a portion of the samples of the defects in the feature space;
labeling the at least a portion of the samples as a T set element;
changing the feature space of the T set element;
deciding upon appropriate parameters;
determining if the parameters can be used to classify the T set element; and
creating knowledge based upon the parameters if the parameters are used.

20. A computer comprising:
a processor; and
a memory coupled to the processor, the memory including a software program for classifying defects in a semiconductor device; the software program comprising directly classifying at least one type of defect based upon a feature space; creating knowledge about the at least one type of defect; and selecting features based upon the direct classifying step.
